(19) United States
(12) Patent Application Publication
(10) Pub. No.: US 2024/0378490 A1
(43) Pub. Date: Nov. 14, 2024

(54) EVENT CLASSIFICATION IN CLOUD-NATIVE SYSTEMS

(71) Applicant: SAP SE, Walldorf (DE)

(72) Inventors: Yangyang CHEN, Zigong (CN); Sang-Jin Lee, Boston, MA (US)

(21) Appl. No.: 18/315,145

(22) Filed: May 10, 2023

(51) Int. Cl. G06N 20/00

(52) U.S. Cl. CPC G06N 20/00

(57) ABSTRACT

Systems and methods include reception of time-series data of each of a plurality of metrics, generation of data instances from the time-series data, each data instance including a value of each of the plurality of metrics and associated with a respective time period, training of a first system using unsupervised learning to generate anomaly values based on the data instances, automatic assignment of incident type labels to a subset of the data instances based on the anomaly values and on incident classification models, presentation of the subset of the data instances and the assigned incident type labels to an operator, determination of an operator-confirmed incident type label for each presented data instance based on input received from the operator, and training of one or more classification systems using supervised learning based on the operator-confirmed incident type labels and the subset of the data instances.

### BACKGROUND

Modern organizations often utilize a system landscape consisting of distributed computing systems providing various computing services. For example, in order to implement desired functionality, an organization may deploy services within computing systems located in on-premise data centers (which themselves may be located in disparate geographic locations) and within data centers provided by one or more infrastructure as-a-service (IaaS) providers. Any number of the computing systems may comprise cloud-based systems (e.g., providing services using scalable-on-demand virtual machines).

Purveyors of distributed systems are rapidly adopting cloud-native implementations using containers, microservices, service meshes, and serverless applications. These implementations provide features such as built-in service discovery and load balancing. automated rollouts and rollbacks, and self-healing. However, as computing architectures become more distributed and complex, it becomes more difficult for humans to understand system dependencies, detect system issues and diagnose the root causes of undesirable system behavior.

System landscapes generate large volumes of monitoring data. The data may include metrics such as node CPU utilization, memory utilization, request statistics, etc. which indicate system and application performance. Normally, system status is monitored using metric thresholds. If the value of a given metric is greater than (or less than) its upper (or lower) threshold, an alert will be triggered. An anomaly in a single metric, detected using a metric-specific threshold, is often insufficient to determine whether or not a system incident of concern has occurred or is occurring. For example, a high value of current CPU usage on a server may or may not indicate a problem. The alerts can therefore be inaccurate and/or meaningless, overwhelming development teams with unnecessary noise and obscuring actual incidents of concern.

Anomalous behavior of technical components (e.g., network adapters, containers) within a system landscape contributes negatively to the overall operational cost of the landscape. It is therefore desirable to efficiently detect and classify anomalies which occur within a system landscape. As microservice environments become increasingly dynamic and scale to hundreds of thousands of hosts, it becomes exponentially difficult detect anomalies in time to prevent business-impacting issues from proliferating.

Moreover, technical anomalies do not always correspond to actual incidents of concern, which will also be referred to herein as events. It is therefore desirable to use the values of multiple metrics to detect anomalies and to determine whether events have occurred. In theory, a classifier may be trained to perform this classification task. However, due to the complexity of this task, a vast amount of labeled data is required to train a classifier to achieve the desired precision and recall.

Labeling large data sets is expensive and requires expert knowledge. For example, even with the assistance of a purpose-designed user-friendly labeling tool, an experienced engineer requires several hours to label six months' worth of data including 300,000 data points spaced at one-minute intervals. Expending such resources on labeling is not acceptable in most organizations. Moreover, since events are quite rare, acquisition of sufficient amounts of labeled data may be practically impossible.

Due to the labeling problems described above, approaches for implementing these classification tasks typically use unsupervised learning techniques. These approaches include the use of recurrent artificial neural networks (RNNs) such as Long Short-Term Memory networks. Such networks predict future samples of a “normal” time series, and the distance between actual values and the predicted samples can be interpreted as a score indicating the extent of anomalous behavior. Other classification approaches such as Nearest Neighbors or Local Outlier Factor determine density measures which may assist in the identification of outliers (i.e., abnormal states) of a system. Local Outlier Probability provides an anomaly score in the range of [0, 1], which can be interpreted as the probability of an instance of a data set being “anomalous” to a given level of confidence.

Unsupervised learning systems are typically less useful and accurate than supervised learning systems. Systems are desired to provide the benefits of supervised learning systems while addressing some of the above-noted labeling issues.

### BRIEF DESCRIPTION OF THE DRAWINGS

FIG. 1 illustrates a system to classify incident types using unsupervised learning and supervised learning according to some embodiments.

FIG. 2 is a flow diagram of a process to label data instances using unsupervised learning and to train a supervised learning system using labeled data instances and according to some embodiments.

FIG. 3 illustrates unsupervised training of an anomaly detector based on data instances according to some embodiments.

FIG. 4 illustrates selection of data instances for operator labeling according to some embodiments.

FIG. 5 is a tabular representation of labeled data instances according to some embodiments.

FIG. 6 is a tabular representation of metrics correlated to incident types according to some embodiments.

FIG. 7 illustrates training of a classification system based on a trained unsupervised learning system and labeled data instances of metrics correlated with a plurality of incident types according to some embodiments.

FIG. 8 illustrates training of a classification system based on a trained unsupervised learning system and labeled data instances of metrics correlated with a single incident type according to some embodiments.

FIG. 9 is a flow diagram of a process to determine incident types using a trained unsupervised learning system and one or more trained classification systems according to some embodiments.

FIG. 10 illustrates a system to raise alerts based on metric data instances, a trained unsupervised learning system, a trained classification system and incident commit policies according to some embodiments.

FIG. 11 is a block diagram of cloud-based servers of a system landscape providing incident type classification according to some embodiments.

### DETAILED DESCRIPTION

The following description is provided to enable any person in the art to make and use the described embodiments. Various modifications, however, will remain readily-apparent to those in the art.

Some embodiments operate to receive time-series data of each of several metrics associated with an application landscape. Data instances are generated based on time-series data and are used to train an anomaly detection system using unsupervised learning to output an anomaly value, or score. Customizable pre-defined strategies are applied to select candidate data instances and to label the selected candidate data instances with an incident type based on their anomaly scores. This incident type may be provided to an operator to determine if remedial action is needed.

While data instances continue to be input to the anomaly detection system, the selected candidate data instances and their system-generated labels are provided to a domain expert. The domain expert confirms or corrects the system-generated labels and these expert-labeled data instances are stored. Once a sufficiently-large set of expert-labeled data instances has been stored, a classifier is trained to determine an incident type using supervised learning and the expert-labeled data instances. In some embodiments, and prior to training the classifier, the expert-labeled data instances may be used to determine a subset of metrics which are correlated with each incident type. In such a case, the classifier may be trained based only on the metrics of the expert-labeled data instances which are correlated to incident types, rather than all metrics of each data instance. This dimension reduction may improve processing efficiency and classifier performance.

The trained classifier may be added to the production pipeline including the trained anomaly detection system. For example, data instances are created based on metric-related time-series data received from a productive system and are submitted to the trained anomaly detection system to determine associated anomaly scores. The scores are input to the trained classifier to identify any corresponding incident types. The incident types may be aggregated/filtered based on different pre-defined/custom strategies for presentation (along with their corresponding data instances, for example) to a development and operations (devops) team.

Embodiments may therefore balance labeling effort against incident detection and classification performance. The use of unsupervised learning during an initial phase advantageously provides some incident detection and classification functionality until a sufficient amount of expert-labeled data is available to train a classifier using supervised learning. Embodiments also advantageously allow the use of custom models to label data instances in the initial phase and to determine whether to raise an alert in response to a detected incident.

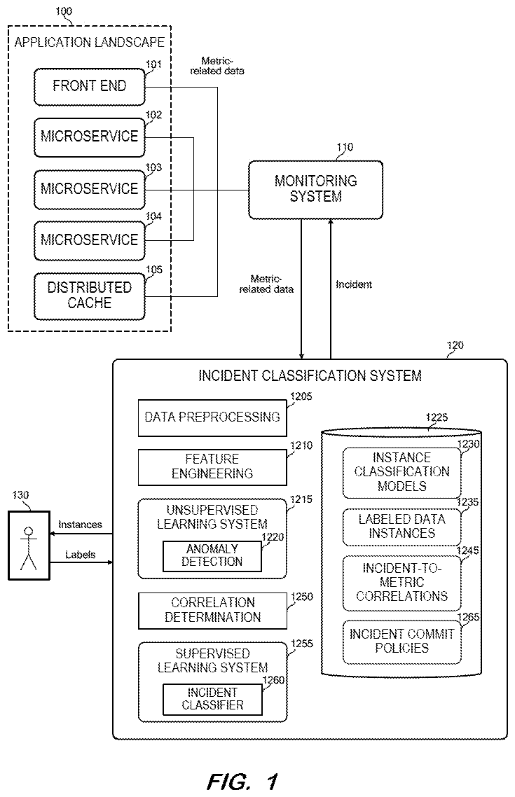

FIG. 1 illustrates a system according to some embodiments. The illustrated components of FIG. 1 may be implemented using any suitable combinations of computing hardware and/or software that are or become known. Such combinations may include cloud-based implementations in which computing resources are virtualized and allocated elastically. In some embodiments, two or more components are implemented by a single computing device.

Application landscape 100 may comprise any number of hardware and software components which may provide functionality to one or more users (not shown). In the present example, application landscape 100 may provide an application such as an online store, and includes front end (i.e., user interface) component 101, microservices 102-104 (e.g., catalog service, payment service, recommendation service) and distributed cache 105 for use by each of microservices 102-104. Embodiments are not limited to a single application or to the components of application landscape 100. Application landscape 100 may comprise disparate cloud-based services, a single computer server, a cluster of servers, and any other combination that is or becomes known.

The hardware and software components of application landscape 100 generate their own metric data and logs as is known in the art. Such data may be related to metrics associated with resource consumption (e.g., CPU utilization, memory utilization, bandwidth consumption), hardware performance (e.g., read/write speeds, bandwidth, CPU speed), application performance (e.g., queries served per second, number of simultaneous sessions), business performance (e.g., number of completed transactions, number of overseas orders), and any other metrics that are or become known. The data generated for each metric may comprise time-series data and may be generated at different respective time intervals.

Monitoring system 110 may comprise any suitable system to receive the metric-related data generated by application landscape 100. Monitoring system 110 may query application landscape 100 for selected metric-related data, may subscribe to the selected metric-related data, may receive metric-related data pushed from application landscape 100, or may acquire the metric-related therefrom using any suitable protocol. Monitoring system 110 may execute an application for recording real-time metric data in a time-series database using an HTTP pull model.

Monitoring system 110 provides time-series data of each of a plurality of metrics received from application landscape 100 to incident classification system 120. Monitoring system 110 may provide the data for each metric (e.g., metrics M₀ to M₉) to incident classification system 120 as an independent time-series (e.g., M₀t₀, M₀t₁, . . . , M⁰tₙ; M₁t₀, M₁t₁, . . . , M₁tₙ; . . . M₉t⁰, M₉t₁, . . . , M₉tₙ). In cases where the data is generated by application landscape 100 at high sampling rates, and in order to reduce processing costs, monitoring system 110 may provide time-series data based on a reasonable time delta Δt (e.g., M₀t₀, M₀ (t₀+1*Δt), M₀ (t₀₊2*Δt), . . . , M₀ (t₀+n*Δt)) if a higher sampling rate is not required for incident classification. Embodiments are not limited thereto.

Application landscape 100 may comprise a microservice-based cloud-native system utilizing a Kubernetes cluster. Kubernetes is an open-source system for automating deployment, scaling and management of containerized applications. Monitoring system 110 may therefore comprise Prometheus, a Kubernetes-compatible monitoring system which collects metrics for every service in the cluster and supports monitoring, processing and alerting applications.

Monitoring system 110 may perform any suitable processing on the data prior to providing the data to incident classification system 120, including but not limited to noise reduction, normalization, and filtering. For example, monitoring system 110 may convert the time-series data into data instances, where each data instance includes values of each metric at a given time point (e.g., [M₀t₀, M₁t₀, . . . , M₉t₀]; [M₀t₁, M₁t₁, . . . , M₉t₁]). In other examples, the time-series data may be normalized in order to avoid artifacts due to the different scales of different metrics M. Pre-processing may also or alternatively be performed by system 120. Conversely, the processes attributed herein to incident classification system 120 may be performed in whole or in part by monitoring system 110 according to some embodiments.

Incident classification system 120 operates as described herein to detect and classify incidents based on time-series data of a plurality of metrics generated by application landscape 100. Detection and classification according to some embodiments includes receiving a data instance including values of a plurality of metrics and, for some of the received data instances, outputting a label specifying an incident type. For other data instances, and as will be described below, either no label is output or a NULL incident type label is output.

Incident classification system 120 includes data preprocessing component 1205 for providing any suitable preprocessing to received training data instances as is known in the art. The preprocessing may include filling empty fields, data scaling, data normalization, data aggregation, etc. The preprocessing may include creation of training data instances based on received time-series data of the metrics, where each training data instance represents values of each metric at a respective time point.

Feature engineering component 1210 may create additional features for the training data instances based on the metric values of the training data instances. As is known in the art, additional features may be created by applying operations to existing features, such as but not limited to diff, std, sun, z-score, min-max, lag, wavelet.

Unsupervised learning system 1215 trains anomaly detection system 1220 to generate anomaly-related values, or scores, for each metric based on training data instances received from feature engineering component 1210. Anomaly detection system 1220 may comprise a Recurrent Neural Network, a Kernel Density Estimation algorithm, a Nearest Neighbors algorithm, an Isolation Forest algorithm, a Local Outlier Factor algorithm or a Local Outlier Probability algorithm, for example. Unsupervised learning system 1215 may comprise any suitable system to train the selected type of anomaly detection system 1220.

Once anomaly detection system 1220 is trained, data instances of metric-related data are received from monitoring system 110 and are input to anomaly detection system 1220 to generate an anomaly score for each metric of each data instance. Instance classification models 1230 are then used to label certain data instances with an incident type based on their associated anomaly scores.

In one example, instance classification models 1230 identify and classify data instances with a highest average anomaly score (or highest metric-specific anomaly score) and/or a data instance including a greatest number of anomalies (e.g., anomaly scores above a threshold). Classification models 1230 may also or alternatively select data instances based on their anomaly scores over time. For example, if 80% of anomaly scores for a given metric are greater than a certain threshold over the last ten minutes, all data instances representing the last ten minutes are labeled with an incident type corresponding to the given metric. In another example, instance classification models 1230 specifies that a data instance is to be labeled with a Memory Pressure incident type if the metric container_memory_working_set_bytes of the data instance is associated with the highest anomaly score among all metrics of the data instance.

The thusly-labeled data instances and their assigned labels are presented to domain expert 130 for review. Expert 130 uses their experienced-based domain knowledge to determine whether the incident type label assigned to each presented data instance is correct and to change the associated label if it is not correct. If a data instance is determined by expert 130 to not be associated with an incident, the data instance may be labeled with a NULL incident type label. The expert-confirmed or-corrected label of each data instance is stored with the data instance in labeled data instances 1235. Labeled data instances 1235 may also include data instances which were not classified by classification models 1230, with those data instances being associated with a NULL incident type label.

According to some embodiments, correlation determination component 1250 determines incident-to-metric correlations 1245 based on labeled data instances 1235. This determination consists of determining, for each incident type, a subset of metrics which are most-closely correlated with the incident type based on the metric values of data instances 1235 which are labeled with the incident type.

Supervised learning system 1255 trains incident classifier 1260 to detect incidents and identify incident types based on labeled data instances 1235. In one example, labeled data instances 1235 are filtered to include only those metrics which are identified as closely correlated with an incident type, and supervised learning system 1255 is trained based on the filtered data instances. In another example, a separate incident classifier is trained for each incident type. The incident classifier for an incident type is trained based on training data instances which include only the metrics which are closely correlated with the incident type.

Trained incident classifier 1260 and anomaly detection system 1220 may then be deployed together in the production environment. For example, incident classification system 120 receives metric-related time-series data from monitoring system 110, which are preprocessed (e.g., including generation of time period-specific data instances based on the received metric-specific time-series data) and fed to trained anomaly detection system 1220. Incident classifier 1260 receives anomaly scores output by trained anomaly detection system 1220 and outputs an incident type (which may include a NULL incident type) for each data instance based on its anomaly scores. In some embodiments, only anomaly scores having characteristics which may indicate an incident are input to incident classifier 1260, so that classifier 1260 need not process the anomaly scores of every data instance.

Once an incident type is detected, incident commit policies 1265 are applied to determine whether and how to escalate the detected incident type. Incident commit policies 1265 may be customizable and incident type-specific. For example, incident commit policies 1265 may indicate that pod-level incidents should be aggregated into service-level incidents. For example, a service includes four pods and system 120 has detected that each pod container is experiencing a CPU pressure incident type. Incident commit policies 1265 may be applied to aggregate the four pod-level incidents into one service-level incident and raise a service-level alert to relevant teams.

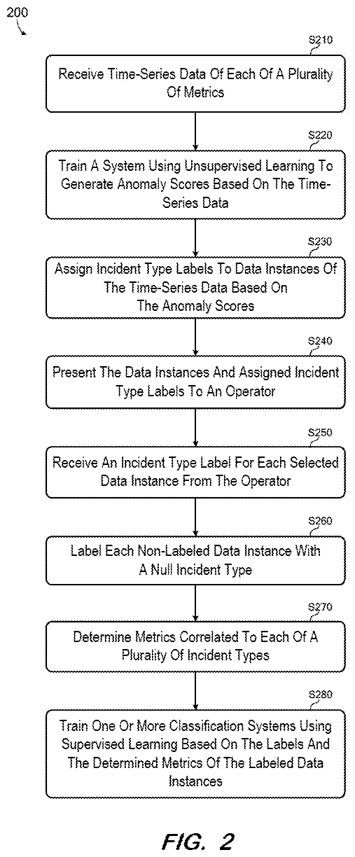

FIG. 2 comprises a flow diagram of process 200 to label data instances using unsupervised learning and to train a supervised learning system using labeled data instances and according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S210, time-series data of each of a plurality of metrics is received. Computing systems may generate hundreds of metrics, many of which may be irrelevant to detection of a particular type of type of incident. The above-mentioned Prometheus system may collect and store metrics for CPU usage and quota, for memory usage and quota, for network usage, for JVM threads, etc.

Next, a system is trained at S220 using an unsupervised learning system to generate anomaly scores for each metric based on the received time-series data. As described above, the time-series data may be preprocessed as is known in the art to, e.g., fill empty fields and scale, normalize and/or aggregate the data. Data instances may also be generated based on received time-series data, where each training data instance represents values of each metric at a respective time point. Additional features may be added to the data instances, with the values of each feature of each data instance calculated based on the metric values of the data instance. The data instances are then used to train the system at S220.

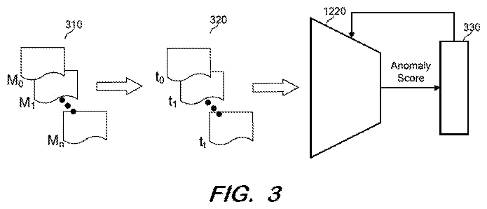

FIG. 3 illustrates time-series data 310 for each of metrics M₀-Mₙ received at S210 in some embodiments. Training data instances 320 are generated based on time-series data 310. where each training data instance 320 represents values of each of metrics M₀-Mₙ at a respective time point t₀-tₜ. Data instances 320 are used to train anomaly detection system 1220 in some embodiments of S220. As noted above, system 1220 may comprise, for example, a Kernel Density Estimation algorithm, a Nearest Neighbors algorithm, an Isolation Forest algorithm, a Local Outlier Factor algorithm or a Local Outlier Probability algorithm.

Training of anomaly detection system 1220 at S220 may include input of training data instances 320, acquisition of resulting output (i.e., anomaly scores) by component 330, modification of system 1220 by component 330 based on the output, and determination to terminate training upon satisfaction of a given target (e.g., an accuracy level, an elapsed time period, a number of iterations). The thusly-trained system 1220 may receive a data instance consisting of the values of the metrics M₀-Mₙ at a particular time point and output a score for each metric predicting a degree to which metric value of the data instance represents an anomaly.

Incident type labels are assigned to data instances of the time-series data based on the anomaly scores of the data instances at S230. Instance classification models are then applied to determine incident type labels for data instances based on their associated anomaly scores. It is anticipated that no incident type labels will be determined for most of the data instances and that a small subset of the data instances will be assigned incident type labels at S230.

The thusly-labeled data instances and their assigned labels are presented to an operator for review at S240. The operator reviews the incident type label assigned to each presented data instance and confirms or corrects the labels. Correction of a label may include labeling a presented data instance with a NULL incident type. Accordingly, an incident type label for each data instance is received from the operator at S250, which, for a given instance, may be the same as or different from the label assigned to the data instance at S230. Each data instance which was not labeled in S230 is assigned a NULL incident type label in S260.

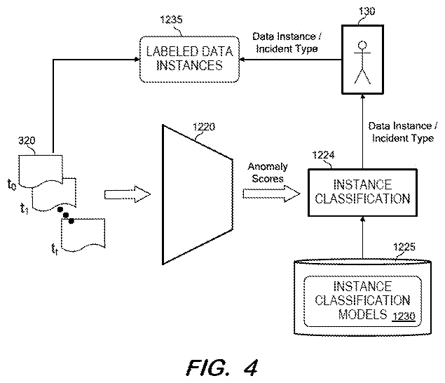

FIG. 4 illustrates S230-S260 according to some embodiments. As shown, data instances 320 are input to trained anomaly detection system 1220 to generate an anomaly score for each metric of each data instance 320. Incident classification component 1224 then applies incident classification models 1230 to determine incident type labels for some of data instances 320 based on their respective anomaly scores. The data instances and their assigned incident labels are presented to operator 130 for review at S240. Operator 130 reviews the incident type label assigned to each presented data instance and confirms or corrects the labels. The confirmed/corrected labels are stored in association with their data instances in labeled data instances 1235. Those data instances 320 which were not assigned a label by instance classification component 1224 are labeled with a NULL incident type and also stored in labeled data instances 1235.

Metrics correlated with each of a plurality of incident types are determined at S270. The determination may be based on the data instances labeled at S250 and S260, and consists of determining, for each incident type, a subset of metrics which are most-closely correlated with the incident type.

FIG. 5 is a tabular representation of a portion of labeled data instances 1235 according to some embodiments. Each row of the tabular representation corresponds to one data instance and therefore includes values for each of metrics M₀-Mₙ at a particular time associated with the instance. The time associated with each data instance is shown in the Instance Time column and the label assigned to the data instance shown in the Incident Type column.

In some embodiments of S270, all data instances associated with a particular incident type are identified and their metric values analyzed to determine a subset of metrics M₀-Mₙ which are correlated with the particular incident type. This process is performed for each incident type in order to determine a subset of metrics M₀-Mₙ for each incident type.

Some embodiments may use the Pearson product-moment correlation coefficient to quantify the relevance r between metrics and incident types.

$$r = \frac{\sum ( {x}_{i} - \overline{x} ) ( {y}_{i} - \overline{y} )}{\sqrt{\sum {( {x}_{i} - \overline{x} )}^{2} \sum {( {y}_{i} - \overline{y} )}^{2}}}$$

$$r = correlation coefficient$$

$${x}_{i} = values of the x - variable in a sample$$

$$\overline{x} = mean of values of the x - variable$$

$${y}_{i} = values of the y - variable in a sample$$

$$\overline{y} = mean of the values of the y - variable$$

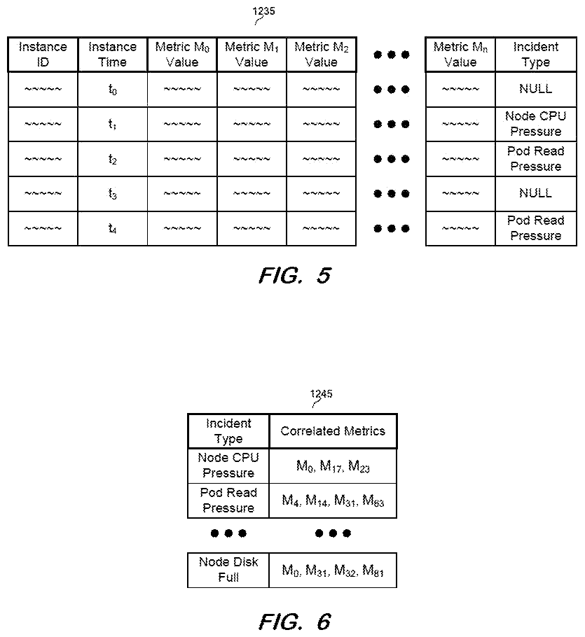

Once determined from the metric values of the data instances associated with an incident type, the Pearson product-moment correlation coefficient provides a number for each metric indicating its degree of relevance to the incident type. S270 may therefore comprise determining, for each incident type, the metrics which have the X largest coefficients for the incident type. Other embodiments may identify all metrics having a coefficient greater than Y for the incident type. FIG. 6 illustrates incident-to-metric correlation table 1245 showing the subsets determined for each incident type at S270 according to some embodiments.

One or more classification systems are trained at S280 using supervised learning to classify incident types based on data instances. The one or more classification systems are trained using the labeled data instances and the correlated metrics determined at S270. That is, only the values of correlated metrics are input to the one or more classification systems during the training. By reducing the number of input metrics, the inference speed of the one or more classification systems, and of the training, is increased. Reducing the number of input metrics may also reduce memory consumption and computing costs.

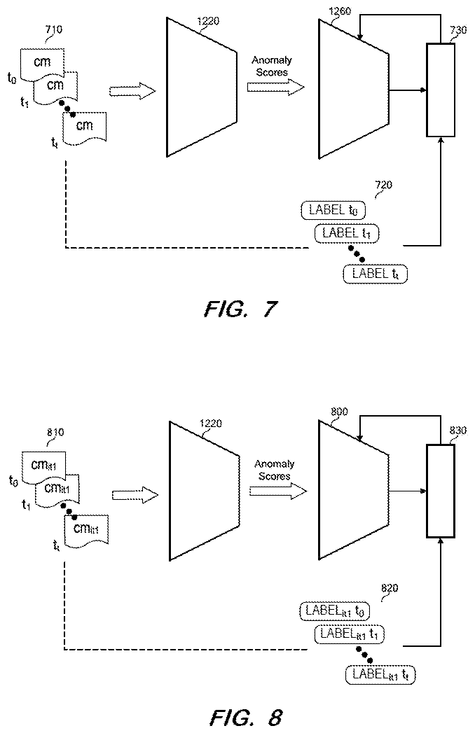

FIG. 7 illustrates the training of a single classification system 1260 at S270 according to some embodiments. FIG. 7 shows training data instances 710 which may be identical to training data instances 320 except for the omission of values of metrics which were not determined to be correlated with incident types at S270. Accordingly, each training data instance 710 is labeled with “cm” to indicate that it includes only values of correlated metrics. Each training data instance 710 is associated with a respective label 720 which is identical to the label assigned to its corresponding data instance 320 in labeled data instances 1235.

During training, training data instances 710 are input to trained anomaly detection system 1220, which outputs an anomaly score for each metric (cm) of each data instance 710. Classification system 1260 receives the anomaly scores and outputs an incident type for each data instance 710. Loss layer 730 compares the output incident types to the associated ground truth labels 720 to determine a total loss. The loss is back-propagated to system 1260 which is modified based thereon. Training continues in this manner until satisfaction of a given performance target or a timeout situation. In some embodiments, classification system 1260 is a decision tree and is trained at S270 using the XGBoost or LightGBM libraries.

FIG. 8 illustrates the training of incident type-specific classification system 800 at S270 according to some embodiments. Training data instances 810 are identical to training data instances 320 but include only values of metrics which are correlated to a particular incident type (e.g., it₁). Each training data instance 810 is labeled with “cmᵢₜ₁” to indicate that it includes only values of metrics which are correlated with incident type it₁. Labels 820 associated with each training data instance 810 indicate whether the training data instance 810 corresponds to incident type it1 or not (e.g., Yes or No, True or False).

At S270, training data instances 810 are input to anomaly detection system 1220, which outputs an anomaly score for each metric (cmᵢₜ₁) of each data instance 810. Classification system 800 receives the scores and outputs a binary decision corresponding to each data instance 810 and loss layer 830 compares the binary decisions to the associated ground truth labels 820 to determine a total loss. The loss is back-propagated to system 800 which is modified based thereon. Training continues in this manner until satisfaction of a given performance target or a timeout situation.

After training, classification system 800 of FIG. 8 is able to infer whether or not a training data instance is associated with incident type it1. S270 may therefore include training of additional incident type-specific binary classification systems. As described with respect to FIG. 8, such a system is trained using the metrics which were determined to be correlated with the incident type which is to be classified by the system.

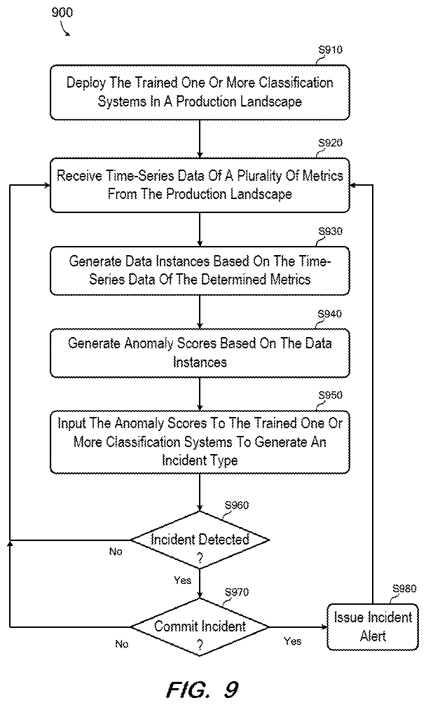

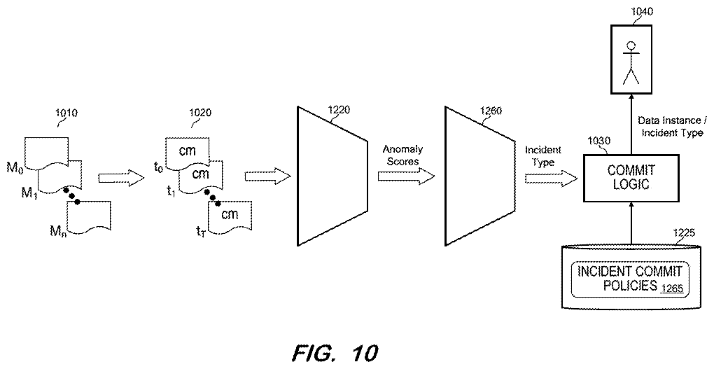

FIG. 9 is a flow diagram of a process to determine incident types using a trained unsupervised learning system and one or more trained classification systems according to some embodiments.

At S910, one or more trained incident classification systems are deployed in a production landscape. According to some embodiments, the one or more trained incident classification systems may be trained as described above. Deployment may consist of adding the one or more trained incident classification systems to an existing incident type-classification pipeline which includes an anomaly detection system as described above with respect to FIG. 4.

Time-series data of a plurality of metrics is received from the production landscape at S920. The time-series data may be received from a monitoring system such as monitoring system 110. Next, at S930, data instances are generated based on the time-series data. The data instances may be generated so as to include only values of the metrics which are correlated to the incident types classified by the one or more classification systems, ignoring other metrics of the time-series data.

Anomaly scores are generated based on the data instances at S940. The anomaly scores may be generated based on an anomaly detection system trained using unsupervised learning as described above. The anomaly detection system may be the same anomaly detection system which was used to train the one or more incident classification systems deployed at S910. The anomaly scores are input to the one or more incident classification systems at S950 to generate an incident type for each data instance.

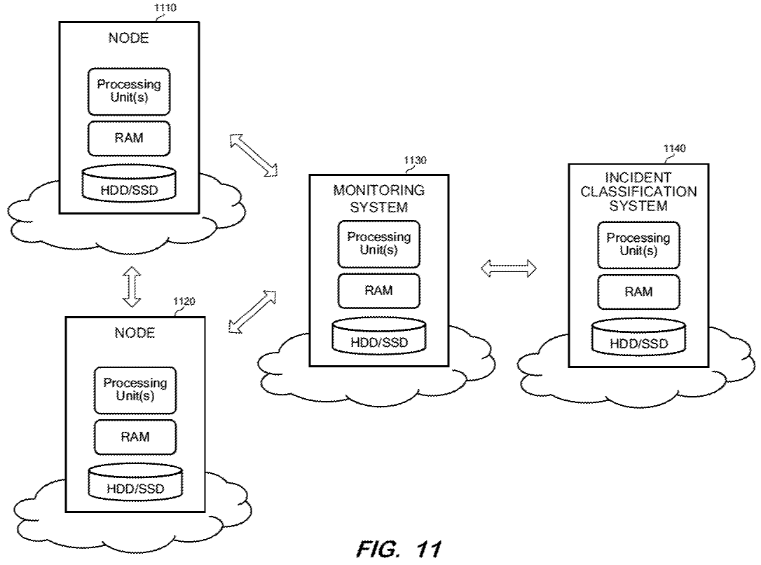

FIG. 10 illustrates deployment of trained incident classification system 1260 in a production landscape according to some embodiments. Metric-related time-series data 1010 is received at S920, and time period-specific data instances 1020 including incident type-correlated metrics are generated at S930 based on metric-specific time-series data 1010.

It is assumed that incident classification system 1260 is a multi-classification system trained to classify several incident types (i.e., the incident types correlated with the metrics of data instances 1020). Data instances 1020 are input to anomaly detection system 1220 to generate anomaly scores for each metric of each instance 1020 at S940. As discussed above, anomaly detection system 1220 may have been previously deployed as shown in FIG. 4 to provide instance classification within the productive landscape and may also have been used to train incident classification system 1260 as shown in FIG. 7.

At S950, incident classifier 1260 receives the anomaly scores output by anomaly detection system 1220 and outputs an incident type (which may include a NULL incident type) for each data instance based on its anomaly scores. In some embodiments, only anomaly scores having characteristics which may indicate an incident are input to incident classifier 1260, so that classifier 1260 need not process the anomaly scores of every data instance.

If no incident is detected (e.g., if all generated incident types are NULL), flow returns from S960 to S920 to receive additional time-series data and proceeds as described above. If one or more non-NULL incident types are generated at S950, flow proceeds from S960 to S970 to determine whether or not to commit the incident.

For example, as shown in FIG. 10, commit logic 1030 may receive the generated non-NULL incident types and apply incident commit policies 1265 to determine whether and how to escalate the detected incident types. Incident commit policies 1265 may be customizable and incident type-specific as described above. If it is determined to commit an incident based on incident commit policies 1265, an incident alert is issued at S980. Incident commit policies 1265 may specify how and to whom an alert should be issued based on the generated incident types. Flow then returns to S920 to receive additional time-series data and continues as described above.

FIG. 11 illustrates a cloud-based database deployment according to some embodiments. The illustrated components may comprise cloud-based compute resources residing in one or more public clouds providing self-service and immediate provisioning, autoscaling, security, compliance and identity management features.

Nodes 1110 and 1120 may comprise servers or virtual machines of a Kubernetes cluster. Nodes 1110 and 1120 may support containerized applications which provide one or more services to users. In this regard, nodes 1110 and 1120 may comprise an implementation of landscape 100. Monitoring system 1130 receives metric-related time-series data from each of nodes 1110 and 1120 as is known in the art. Incident classification system 1140 receives this data (or a subset) thereof from monitoring system 1130. Incident classification system 1140 may operate as described herein to detect and classify incidents based on the received time-series data.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable program code; and
at least one processing unit to execute the processor-executable program code to cause the system to:
receive time-series data of each of a plurality of metrics;
generate data instances from the time-series data, each data instance including a value of each of the plurality of metrics and associated with a respective time period;
train a first system using unsupervised learning to generate anomaly values based on the data instances;
automatically assign incident type labels to a subset of the data instances based on the anomaly values and on incident classification models;
present the subset of the data instances and the assigned incident type labels to an operator;
determine an operator-confirmed incident type label for each presented data instance based on input received from the operator; and
train one or more classification systems using supervised learning based on the operator-confirmed incident type labels and the subset of the data instances.

2. A system according to claim 1, the at least one processing unit to execute the processor-executable program code to cause the system to:
label the generated data instances which are not in the subset of the data instances with a NULL incident type,
wherein the one or more classification systems using supervised learning based on the operator-confirmed incident type labels and the subset of the data instances, and on the generated data instances which are not in the subset of the data instances and labeled with a NULL incident type.

3. A system according to claim 1, wherein the first system is trained to generate an anomaly value for each metric value of a data instance, and
wherein the incident type labels are automatically assigned to a subset of the data instances based on the anomaly values for each metric value of each data instance of the subset of the data instances and on the incident classification models.

4. A system according to claim 1, the at least one processing unit to execute the processor-executable program code to cause the system to:
determine one or metrics correlated to each of the plurality of incident types based on the subset of the data instances and the assigned incident type labels,
wherein the one or more classification systems are trained using supervised learning based on the one or more correlated metrics of the subset of the data instances.

5. A system according to claim 4,
wherein training the one or more classification systems comprises training a single classification system using supervised learning based on the operator-confirmed incident type labels and on only values of the subset of the data instances of the one or more correlated metrics.

6. A system according to claim 4,
wherein training the one or more classification systems comprises:
training a first classification system using supervised learning based on only values of the subset of the data instances of one or more metrics correlated with a first incident type; and
training a second classification system using supervised learning based on only values of the subset of the data instances of one or more metrics correlated with a second incident type.

7. A computer-implemented method comprising:
receiving time-series data of each of a plurality of metrics;
generating data instances from the time-series data, each data instance including a value of each of the plurality of metrics and associated with a respective time period;
training a first system using unsupervised learning to generate anomaly values based on the data instances;
automatically assigning incident type labels to a subset of the data instances based on the anomaly values and on incident classification models;
presenting the subset of the data instances and the assigned incident type labels to an operator;
determining an operator-confirmed incident type label for each presented data instance based on input received from the operator; and
training one or more classification systems using supervised learning based on the operator-confirmed incident type labels and the subset of the data instances.

8. A method according to claim 7, further comprising:
labeling the generated data instances which are not in the subset of the data instances with a NULL incident type,
wherein the one or more classification systems using supervised learning based on the operator-confirmed incident type labels and the subset of the data instances, and on the generated data instances which are not in the subset of the data instances and labeled with a NULL incident type.

9. A method according to claim 7, wherein the first system is trained to generate an anomaly value for each metric value of a data instance, and wherein the incident type labels are automatically assigned to a subset of the data instances based on the anomaly values for each metric value of each data instance of the subset of the data instances and on the incident classification models.

10. A method according to claim 7, the at least one processing unit to execute the processor-executable program code to cause the system to:
determine one or metrics correlated to each of the plurality of incident types based on the subset of the data instances and the assigned incident type labels,
wherein the one or more classification systems are trained using supervised learning based on the one or more correlated metrics of the subset of the data instances.

11. A method according to claim 10, wherein training the one or more classification systems comprises training a single classification system using supervised learning based on the operator-confirmed incident type labels and on only values of the subset of the data instances of the one or more correlated metrics.

12. A method according to claim 10,
wherein training the one or more classification systems comprises:
training a first classification system using supervised learning based on only values of the subset of the data instances of one or more metrics correlated with a first incident type; and
training a second classification system using supervised learning based on only values of the subset of the data instances of one or more metrics correlated with a second incident type.

13. A computer-readable medium storing processor-executable program code, the program code executable by a computing system to:
receive time-series data of each of a plurality of metrics;
generate data instances from the time-series data, each data instance including a value of each of the plurality of metrics and associated with a respective time period;
train a first system using unsupervised learning to generate anomaly values based on the data instances;
automatically assign incident type labels to a subset of the data instances based on the anomaly values and on incident classification models;
present the subset of the data instances and the assigned incident type labels to an operator;
determine an operator-confirmed incident type label for each presented data instance based on input received from the operator; and
train one or more classification systems using supervised learning based on the operator-confirmed incident type labels and the subset of the data instances.

14. A medium according to claim 13, the program code executable by a computing system to:
label the generated data instances which are not in the subset of the data instances with a NULL incident type,
wherein the one or more classification systems using supervised learning based on the operator-confirmed incident type labels and the subset of the data instances, and on the generated data instances which are not in the subset of the data instances and labeled with a NULL incident type.

15. A medium according to claim 13, wherein the first system is trained to generate an anomaly value for each metric value of a data instance, and
wherein the incident type labels are automatically assigned to a subset of the data instances based on the anomaly values for each metric value of each data instance of the subset of the data instances and on the incident classification models.

16. A medium according to claim 13, the at least one processing unit to execute the processor-executable program code to cause the system to:
determine one or metrics correlated to each of the plurality of incident types based on the subset of the data instances and the assigned incident type labels,
wherein the one or more classification systems are trained using supervised learning based on the one or more correlated metrics of the subset of the data instances.

17. A medium according to claim 16,
wherein training the one or more classification systems comprises training a single classification system using supervised learning based on the operator-confirmed incident type labels and on only values of the subset of the data instances of the one or more correlated metrics.

18. A medium according to claim 16,
wherein training the one or more classification systems comprises:
training a first classification system using supervised learning based on only values of the subset of the data instances of one or more metrics correlated with a first incident type; and
training a second classification system using supervised learning based on only values of the subset of the data instances of one or more metrics correlated with a second incident type.
